(19) United States
(12) Patent Application Publication
(10) Pub. No.: US 2024/0264571 A1
(43) Pub. Date: Aug. 8, 2024

(54) MANAGEMENT OF ENGINEERED WOOD PRODUCT MANUFACTURE

(71) Applicant: Smartech The Industry Pivot Ltd., Caesarea (IL)

(72) Inventors: Amnon Shoshani, Givat-Ada (IL); Hanoch Magid, Bat Hen (IL); Oren Yahav, Ramat Yishai (IL)

(73) Assignee: Smartech The Industry Pivot Ltd., Caesarea (IL)

(21) Appl. No.: 18/567,122

(22) PCT Filed: Jun. 2, 2022
(86) PCT No.: PCT/IB2022/055163

§ 371 Date: Dec. 5, 2023

Related U.S. Application Data
(60) Provisional application No. 63/197,410, filed on Jun. 6, 2021.

(51) Int. Cl. G05B 13/02

(52) U.S. Cl. CPC G05B 13/0265

(57) ABSTRACT

A method of controlling processing of wood particles into engineered wood products includes sensing interaction information associated with interaction between a plurality of steps in manufacturing the engineered wood products, or interaction between a plurality of properties associated with materials used to make the engineered wood products, or interaction between said plurality of steps and said plurality of properties, or interaction between said plurality of steps or said plurality of properties and an additional external factor which is external to said plurality of steps or said plurality of properties, processing the interaction information with machine learning and deriving from the machine learning improvement information associated with improving properties or yields or profitability of the engineered wood products, and implementing the improvement information back in the processing of the wood particles to achieve engineered wood products with improved properties or yields or profitability.

### FIELD OF THE INVENTION

The present invention relates generally to manufacture of engineered wood products, and particularly to using machine learning to improve manufacture of engineered wood products.

### BACKGROUND OF THE INVENTION

Engineered wood products such as oriented strand board (OSB), particle board, medium density fiberboard (MDF), flake board, particleboard, plywood and the like are generally produced by blending a binder composition with wood flakes, wood strips or strands, pieces of wood or other lignocellulosic materials. This blended composition is then typically formed into a mat which is compressed between heated platens or plates to set the binder and bond the flakes, strands, strips, pieces, etc. together in densified form.

### SUMMARY OF THE INVENTION

The present invention seeks to improve manufacture of engineered wood products using machine learning techniques, such as reinforcement learning (RL), deep reinforcement learning (DRL), neural networks, graph network, graph learning, any form of artificial intelligence, and others and any combination thereof, (any one or all of which being referred to as “machine learning”), as is described more in detail hereinbelow.

The present invention enables autonomous manufacturing management of one or more manufacturing units or stations or set of actions in the manufacture of engineered wood products using machine learning techniques. The management decisions can be used to weigh the benefit or deficit (in terms of time, profit or other factor) of any change in the manufacturing process and to independently change or modify any line parameter according to a policy that manages such benefits and deficits. The present invention may make multiple changes and modifications according to a stream of data, which activities a human is incapable of performing.

One use of machine learning is to use a sensor to measure a property of wood, such as moisture content or density, and use machine learning techniques to learn the changes of that property and act in accordance with those changes. In contrast, the present invention improves the manufacture of engineered wood products not by monitoring an individual property or properties, but rather by sensing and monitoring a plurality of properties and/or activities (activities include, but are not limited to, steps in a process made by humans and/or machines) and using machine learning techniques to learn the interaction between properties and/or activities and using the information learned from the interaction between properties and/or activities to improve the manufacture of engineered wood products. The inventors have found there is a dramatic and significant increase in the improvement of manufacture of engineered wood products (in terms of productivity, time benefits, cost benefits, and quality of product, to name a few) by learning the interaction and taking action that takes into account the learned information, as opposed to simply learning individual properties and taking action based on learning those individual properties without interaction between them.

For example, one may use a sensor to measure moisture content of wood and use machine learning techniques to learn about changes in the moisture content and then take actions to improve the desired moisture content based on information from the machine learning. In contrast, the present invention uses sensors to monitor moisture content, density, chemical properties, strand size or geometry, and others, and then learns the interaction between two or more different properties and then takes actions to improve one or more properties (such as improving just the moisture content or improving the moisture content and the density or other combination of properties) or to improve the desired final product, parts of the production line or the entire production line in terms of productivity, time benefits, cost benefits, profitability, production capacity and/or quality or performance of product.

The interactions between the properties and the properties relevant to any interactions may change with time and the invention takes this into consideration and is not bound by previously sensed and recorded interactions. The interactions between the properties and the properties relevant to any interactions may change from time to time to address change in operator or management goals or instructions. For example, the current invention enables the optimization of the relations between production capacity, cost, profitability, and product quality and enables managing a controlled preference of one or more of them, over the others.

Another interaction which can be used by the present invention is the interaction between different steps of the manufacturing process, such as but not limited to, the interaction between properties of the wood at the logging, debarking, stranding, cutting, drying, blending, forming, pressing or sawing stations, and/or interaction between the activities at the logging, debarking, stranding, cutting, drying, blending, forming, pressing or sawing stations, and/or the interaction between properties of the wood and the activities at the logging, debarking, stranding, cutting, drying, blending, forming, pressing or sawing stations.

Another interaction which can be used by the present invention is the interaction between properties of the wood and/or the activities at the different stations and external factors. External factors include, but are not limited to data relating to season, time of day, ambient temperature at the production site, ambient temperature or other conditions at certain times at the wood tree growing sites, particular labor or labor shift that performs the activity, material prices, product sale prices, markets conditions, currency rates, storage capacity at the production site, supply chain data, worker behavior (e.g., how the worker performs on one day as opposed to another day, or how the worker performs after consuming alcohol or returning from vacation or other parameters related to worker characteristics or behavior).

There is provided in accordance with a non-limiting embodiment of the invention a method including controlling processing of wood particles into engineered wood products by sensing interaction information associated with interaction between a plurality of steps in manufacturing the engineered wood products or interaction between a plurality of properties associated with materials used to make the engineered wood products, or interaction between the plurality of steps and the plurality of properties, or interaction between the plurality of steps or the plurality of properties and an additional external factor which is external to the plurality of steps or the plurality of properties, processing the interaction information with machine learning and deriving from the machine learning improvement information associated with improving properties or yields or profitability of the engineered wood products, and implementing the improvement information back in the processing of the wood particles to achieve engineered wood products with improved properties or yields or profitability.

One of the steps in manufacturing the engineered wood products may include processing at a log yard, cutting station, dryer, blender, forming or pressing station, or sawing station.

The plurality of properties may include at least two of temperature, torque, force, pressure, flow, moisture content, rotating speed, energy consumption, strand size or geometry, density, material physical properties, material chemical properties and constituent content.

The external factor may include at least one of season, time of day, ambient temperature, parameters from tree growing locations, machine wellness parameters, energy consumption, vibration, sound, reflection, particular labor or labor shift that performs an activity, worker behavior, data related to workers material prices, markets conditions, currency rates, storage capacity or supply chain data.

At least one of production yield or capacity, cost, profitability, and product quality may be improved to a controlled level, while the rest of production yield or capacity, cost, profitability, and product quality are not affected within a controlled tolerance level or are purposely degraded to a controlled level.

There is provided in accordance with a non-limiting embodiment of the invention a controller in operative communication with sensors, said controller being configured to control processing of wood particles into engineered wood products by processing interaction information, sensed by said sensors, associated with interaction between a plurality of steps in manufacturing the engineered wood products or interaction between a plurality of properties associated with materials used to make the engineered wood products, or interaction between said plurality of steps and said plurality of properties, or interaction between said plurality of steps or said plurality of properties and an additional external factor which is external to said plurality of steps or said plurality of properties, said controller being configured to process the interaction information with machine learning and deriving from the machine learning improvement information associated with improving properties or yields or profitability of the engineered wood products, and implementing the improvement information back in the processing of the wood particles to achieve engineered wood products with improved properties or yields or profitability.

### BRIEF DESCRIPTION OF THE DRAWINGS

The present invention will be understood and appreciated more fully from the following detailed description taken in conjunction with the drawings in which:

FIG. 1 is a block diagram of a management control system/method for manufacturing engineered wood products, in accordance with a non-limiting embodiment of the present invention.

### DETAILED DESCRIPTION

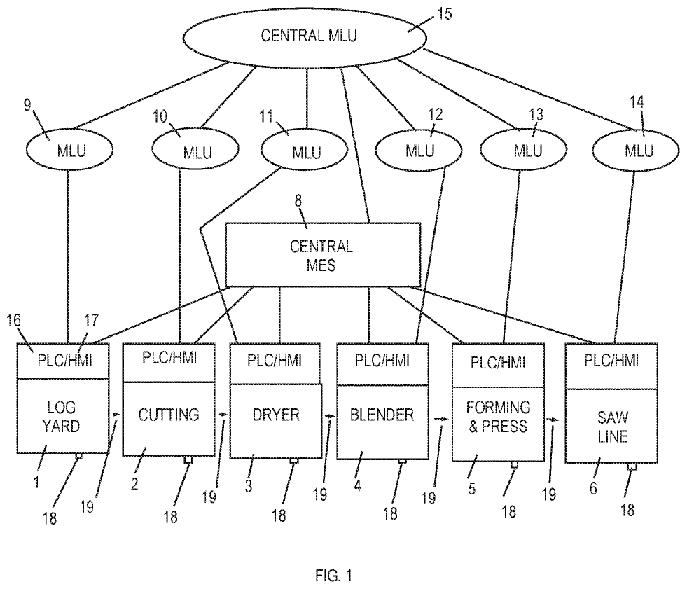

Reference is now made to FIG. 1, which illustrates a block diagram of a management control system/method for manufacturing engineered wood products, in accordance with a non-limiting embodiment of the present invention.

Each step, station or phase of the manufacturing process includes a programmable logic controller (PLC) (16) with a human-machine interface (HMI) (17). Each PLC (16) and HMI (17) cooperate with one or more sensors (18) to sense a parameter of the production process which provides feedback to a machine learning unit (MLU) (9-14), which is a processor that uses machine learning techniques, such as but not limited to, supervised learning, unsupervised learning, reinforcement learning (RL), deep reinforcement learning (DRL), graph network, graph learning, artificial neural networks, artificial intelligence and more, and any combination thereof. The individual machine learning units may cooperate with a central machine learning unit (15), which also may communicate with a central programmable logic controller that has a human-machine interface and/or may communicate with a central manufacturing execution system (MES) (8). Alternatively or additionally, the individual machine learning units may communicate with each other.

The system of the invention encompasses each and every phase of the production, starting from the log yard. At the log yard (1), sensors (18) may be used to measure different properties of the wood/log, such as but not limited to, moisture content, density, and chemical properties or constituents, such as lignin or cellulose content. In addition the system of invention may encompass data from the PLC (16) and HMI (17) such as but not limited to operator behavior and mode of operation, sequences between truck loads, the location of each logs, time laps of each crane load and others. The MLU (9) at this station records the data and learns from the data information to be used in the manufacturing process, such as but not limited to which logs in the log yard provide the best yield, which types of wood in a particular log yard provide the best yield, what time in the logging season provides better outputs, what is the optimal action a worker such as an operator can do at any certain minute (where to take the logs from, how much logs to take in each crane batch, to what height should the logs be lifted etc.), according to such learning results and policies dictated by the line managers and/or operators that manage the desired benefits such as, but not limited to desired technical parameters and/or cost of production at the production line and/or production line profitability, log yard output capacity (capacity in this application may be also referred to as “yield”) and/or the production line output capacity, the quality of products and/or each of the products produced by the production line and others. Accordingly, MLU (9) can provide recommendations as to preferred line parameters that the operator can relate to and/or independently change or modify any line parameter to meet the policy goals. All of this is done by learning interaction between properties and/or different steps of the manufacturing process and/or external factors, and using the information learned from the interaction to improve the manufacture of the engineered wood product.

It is noted that machine learning is often used in games and financial programs, in which the machine learning algorithm is allowed to make millions of iterations to learn about different situations or problems and possible solutions, or machine learning algorithms are allowed to make millions of iterations on digital twins. In such uses of machine learning, there is no problem of the machine learning process making millions of mistakes until a viable solution is found. However, in the context of the present invention, for use in manufacture of engineered wood products, which involve very complicated and large production lines, in which creating digital twins is either technically impossible or extremely complicated and expensive, it would be disastrous, in terms of safety and production, to allow for any error, even a single error.

Therefore, in one aspect of the invention, in contrast to the use of machine learning in other applications, a “permissible band” is defined in accordance with safety standards and/or other operator requirements, which limits the machine learning algorithm to performing iterations within the defined permissible band. In this manner, the machine learning algorithm is free to perform millions of iterations, but none of the iterations involves any solution beyond the safe permissible band. The permissible band may be defined in a variety of ways, for example, in one embodiment of this invention, the permissible band may be defined as actions already taken by an operator, throughout a defined period, at a certain line situation without causing a significant negative effect.

Accordingly, the changes and modifications made according to the present invention may be limited by safety or other, boundaries dictated by the operator. Independent autonomous operation of the MLU may be allowed within the boundaries and not allowed outside them thus enabling the MLU to autonomously operate in a working production line without harming it or causing danger to humans or property. The boundaries may be changed from time to time; for example, the permissible band may be widened or narrowed, depending on the situation and/or previous results. In one embodiment of this invention, extending or narrowing the permissible band may be done manually by a human operator or automatically by the MLU if an operation was previously allowed by the human operator or used by a human operator or only according to rules approved by him.

Typically, logs are sent to a debarker and a strander or other cutting station (2) for forming flakes, strands, strips, pieces, ply etc., all referred to as wood particles. At this station (2), sensors (18) may be used to measure different properties of the wood particles, such as but not limited to, moisture content, density, chemical properties or constituents, such as lignin or cellulose content, color and other properties. Other sensors may be used to monitor different parameters of the cutting process, such as but not limited to, force needed to cut the wood, strength and sharpness of the cutters, orientation of the cutters, cutting speed, length, width and thickness of the cut wood particles, and more. It is noted that sensors under this invention may provide any type of signal which may be an analog or digital signal or a calculated signal which may be median, average, factored, algorithm processed, or any other type of calculated signal, and/or a signal that is provided by a neural network or a signal which is completely calculated without the existence of a real physical sensor, or any combination thereof.

In addition, the MLU at this station (10) encompasses data from the PLC (16) and HMI (17) such as but not limited to sequence between cuttings, operator behavior, manual processes done by operators, amount and length of stops done by each operator and others. The MLU at this station records the data and learns from the data information to be used in the manufacturing process, such as which wood particles are better suited for the particular engineered wood product, such as oriented strand board, flake board, particleboard, veneer, medium density fiberboard, high density fiberboard or other product. Additionally, the MLU at this station records the data and learns from the data information about the cutting and can optimize the type of cutting, cutting speed, preferred operation parameters such as speed, pressures, manual interventions, knives replacements, other machine wellness parameters and other parameters for a particular type of wood or desired wood particle shape and characters to be obtained in order to meet the manufacturing policies such as, but not limited to, technical required parameters, cost of production at the production line and/or production line profitability, strander output capacity and/or the production line output capacity, wood particles quality and/or the quality of products and/or each of the products produced by the production line and others. According to such learning results and policies dictated by the line managers and/or operators that manages desired benefits. MLU (10) can provide recommendation as to preferred line parameters that the operator can relate to and/or independently change or modify any line parameter to meet the policy goals. The changes and modifications made according to the present invention may be limited by safety or other boundaries dictated by the operator. Independent autonomous operation of the MLU may be allowed within the boundaries and not allowed outside them thus enabling the MLU (10) to autonomously operate in a working production line without harming it or causing danger to humans or property. The boundaries may be change from time to time.

The wood particles may be sent from the strander or any other cutting station (2) to a dryer (3). At this station (3), sensors (18) may be used to measure different properties of the wood particles, such as but not limited to, moisture content, density, chemical properties or constituents, such as lignin or cellulose content, color and other properties. Other sensors may be used to monitor different parameters of the drying process, such as but not limited to, drying temperature, electrical and other energy usage needed to power the dryers, drying time, parameter relating to chemicals at the exhaust air and other parameters. The MLU at this station (11) records the data from the sensors and the PLC (16) and HMI (17) such as but not limited to, temperature, moisture content, drying time, etc., and learns from the data information to be used in the manufacturing process, such as which moisture contents of dried wood particles are better suited for the particular engineered wood product, such as oriented strand board, flake board, particleboard, veneer, medium density fiberboard, high density fiberboard or other product. Additionally, the MLU at this station (11) records the data and learns from the data information about the drying and can optimize the type of drying and drying speed and other parameters for a particle type of wood or desired wood particle to be obtained in order to meet the manufacturing policies such as, but not limited to, technical required parameters at the dryer or other stations, cost of production at the production line and/or production line profitability, dryer output capacity and/or the production line output capacity, wood particles quality and/or the quality of products and/or each of the products produced by the production line and others. According to such learning results and policies dictated by the line managers and/or operators that manage required benefits, MLU (11) can provide recommendations as to preferred line parameters to which the operator can relate; the operator may alternatively or additionally independently change or modify any line parameter to meet the policy goals. The changes and modifications made according to the present invention may be limited by safety or other boundaries dictated by the operator. Independent autonomous operation of the MLU may be allowed within the boundaries and not allowed outside them thus enabling the MLU to autonomously operate in a working production line without harming it or causing danger to humans or property. The boundaries may be change from time to time.

Without limitation, it is noted that ligno-cellulosic wood materials can have a moisture content of 5-60% by weight before drying, and after drying may have a moisture content of about 2-20 wt %.

The dried wood particles may be sent from the dryer (3) to a blending station for wood and/or chemical blending with the dried wood particles (4). The blending station can be any type of system that mixes or combines the wood particles with chemicals, such as but not limited to, binders of any kind, water repellent additives (such as waxes of any kind) and other chemicals such as pest repellents, hardening accelerators, radiation absorbers, acoustic absorbers, etc.

Binder compositions used throughout the process may include, without limitation, phenol formaldehyde resins, urea formaldehyde resins and isocyanates. It is noted, for example, that isocyanate binders generally have high adhesive and cohesive strength, excellent flexibility in formulation, excellent versatility with respect to cure temperature and rate, excellent structural properties, and excellent ability to bond with lignocellulosic materials having high water contents and no formaldehyde emissions. The disadvantages of isocyanates are difficulty in processing due to their high reactivity, adhesion to platens, lack of cold tack, high cost and the need for special storage.

A major processing difficulty encountered with isocyanate binders is the rapid reaction of the isocyanate with water present in the lignocellulosic material and any water present in the binder composition itself. One method for minimizing this difficulty is to use only lignocellulosic materials having low moisture content (e.g., moisture content of from about 3 to about 8%). This low moisture content is generally achieved by drying the cellulosic raw material to reduce the moisture content. Such drying is, however, expensive may be damaging for the wood particles, affect additional line parameters and may have a significant effect upon the economics of the process. Use of materials having low moisture contents is also disadvantageous because panels made from the dried composite material tend to absorb moisture and swell when used in humid environments. Phenol formaldehyde resins and urea formaldehyde resins present other advantages and difficulties.

The invention may be used to provide solutions to these and other problems by sensing and monitoring all of the above factors and using reinforcement learning to optimize and control these factors to reduce manufacturing costs and time and achieve an engineered wood product of superior quality.

At this station (4), sensors (18) may be used to measure different properties of the wood particles, such as but not limited to, moisture content, density, chemical properties or constituents, such as lignin or cellulose content, color and other properties. Other sensors may be used to monitor different parameters of the blending process, such as but not limited to, blending temperature, electrical usage needed to power the blender, blending rotating speed and time, chemical flow and pressure, size of wood chips after the blending and other parameters.

The MLU at this station (12) records the data and learns from the data information to be used in the manufacturing process, such as which dried wood particles are better suited for the particular engineered wood product, such as oriented strand board, flake board, particleboard, veneer, medium density fiberboard, high density fiberboard or other product. Additionally, the MLU at this station (12) records the data and learns from the data information about the blending and can optimize the type of blending and blending speed and other parameters for a particular type of wood or desired wood particle to be obtained in order to meet the manufacturing policies.

According to such learning results and policies dictated by the line managers and/or operators that manages required benefits such as, but not limited to, technical required parameters at the blending process or other stations, cost of production at the production line and/or production line profitability, blending output capacity and/or the production line output capacity, wood particles quality and/or the quality of products and/or each of the products produced by the production line and others, MLU (12)) can provide recommendation as to preferred line parameters that the operator can relate to and/or independently change or modify any line parameter to meet the policy goals. The changes and modifications made according to the present invention may be limited by safety or other boundaries dictated by the operator. Independent autonomous operation of the MLU may be allowed within the boundaries and not allowed outside them thus enabling the MLU to autonomously operate in a working production line without harming it or causing danger to humans or property. The boundaries may be change from time to time.

The blended composition may then be sent to a forming and/or pressing station (5).

Within this process, the binder-coated wood particles may be spread on a conveyor belt to provide a first surface ply or layer having wood particles oriented generally in line with the conveyor belt, then one or more plies of wood particles that will form an interior ply or plies of the finished board is (are) deposited on the first ply such that the one or more plies is (are) oriented generally perpendicular to the conveyor belt. Then, another surface ply having wood particles oriented generally in line with the conveyor belt is deposited over the intervening one or more plies having wood particles oriented generally perpendicular to the conveyor belt. Plies built-up in this manner have wood particles oriented generally perpendicular to a neighboring ply insofar as each surface ply and the adjoining interior ply. The layers of oriented “strands” or “flakes” or “wood particles” are finally exposed to heat and pressure to bond the strands and binder together.

Using this process, the blended composition may be formed into a mat which is compressed between heated platens or plates to set a binder or other adhesive and bond the flakes, strands, strips, pieces, etc., together in densified form. It is noted, without limitation, that some conventional processes are generally carried out at temperatures of from about 150-250° C. Steam may be used as part of the production process and/or when the board thickness prohibits the transfer of heat from the press platens to the center of the board. Other heating methods such as ultra-wave may be used as well. Steam injection before and/or during the press closing cycle enables the center of the board to be preheated before the press is closed and ensures a complete cure throughout the thickness of the board. The conventional processes also generally require that the moisture content of the lignocellulosic material be between 2 and 12% before it is blended with the binder and a controlled moisture content is important to the press performance.

The MLU at this station (13) records the data and learns from the data information to be used in the manufacturing process, such as length of each of the press cycle sup-processes, temperature and pressure of each part of the press, steam pressure at the press and many others. Additionally, the MLU at this station (13) records the data and learns from the data information about the forming and pressing processes and can optimize the type of pressing and pressing parameters and other parameters for a particular type of wood or desired wood to be obtained in order to meet the manufacturing policies.

According to such learning results and policies dictated by the line managers and/or operators that manages required benefits such as, but not limited to, technical required parameters at the pressing station or other stations, cost of production at the production line and/or production line profitability, press output capacity and/or the production line output capacity, press output quality and/or the quality of products and/or each of the products produced by the production line and others, MLU (13) can provide recommendation as to preferred line parameters that the operator can relate to and/or independently change or modify any line parameter to meet the policy goals. The changes and modifications made according to the present invention may be limited by safety or other boundaries dictated by the operator. Independent autonomous operation of the MLU may be allowed within the boundaries and not allowed outside them thus enabling the MLU to autonomously operate in a working production line without harming it or causing danger to humans or property. The boundaries may be change from time to time.

From the pressing (5), the resulting product may be sent to the saw line station (6) where it is cut to size and prepared for shipping.

The MLU at this station (14) records the data and learns from the data information to be used in the manufacturing process, such as without limitation, saw speed, pressure on the saw, product weight at the saw, weight and size of bulk products after the saw, sound of the sawing process and many others. Additionally, the MLU at this station (14) records the data and learns from the data information and can optimize pressing profiling and processes and other parameters required for a particular process as required to be obtained in order to meet the manufacturing policies.

According to such learning results and policies dictated by the line managers and/or operators that manage required benefits such as, but not limited to, technical required parameters at the saw line or other stations, cost of production at the production line and/or production line profitability, saw line output capacity and/or the production line output capacity, boards and/or boards edges quality and/or the quality of products and/or each of the products produced by the production line and others, MLU (14) can provide recommendations as to preferred line parameters that the operator can relate to and/or independently change or modify any line parameter to meet the policy goals. The changes and modifications made according to the present invention may be limited by safety or other boundaries dictated by the operator. Independent autonomous operation of the MLU may be allowed within the boundaries and not allowed outside them, thus enabling the MLU to autonomously operate in a working production line without harming it or causing danger to humans or property. The boundaries may be change from time to time.

According to this invention the MLU may also use data from sensors which are external to the defined processes (19), such as, but not limited to, vibration, sound or laser/light sensors which may provide enabling data.

According to this invention each MLU station (9-14) may use data of results of algorithm from other MLUs and or receive data from the central MLU (15) or any type of external factor.

Board product uniformity and quality is sensitive to raw material and formulation variations. Often, panel components are not measured directly but inferred from application rates. This situation has led to a gap in information about parameters such as, but not limited to, production process efficiency, production process profitability or production process outcome quality which limits the ability to improve the process and/or each of its stages.

Once again, the invention may be used to provide solutions to these and other problems by sensing and monitoring all of the above factors and using reinforcement learning to optimize and control these factors to reduce manufacturing costs and time and achieve an engineered wood product of superior quality.

For example, the invention may be used to control pressure of the pressing process, conveyor speeds, binder application (e.g., type of binder, application speed, binder viscosity, binder spreading), temperature control, chemical reaction control and many others. The invention may generate protocols, algorithms, simulation models, worker safety criteria and others, to learn how to optimize the processes.

What is claimed is:

1. A method comprising:
controlling processing of wood particles into engineered wood products by sensing interaction information associated with interaction between a plurality of steps in manufacturing the engineered wood products or interaction between a plurality of properties associated with materials used to make the engineered wood products, or interaction between said plurality of steps and said plurality of properties, or interaction between said plurality of steps or said plurality of properties and an additional external factor which is external to said plurality of steps or said plurality of properties, processing the interaction information with machine learning and deriving from the machine learning improvement information associated with improving properties or yields or profitability of the engineered wood products, and implementing the improvement information back in the processing of the wood particles to achieve engineered wood products with improved properties or yields or profitability.

2. The method according to claim 1, wherein one of the steps in manufacturing the engineered wood products comprises processing at a log yard.

3. The method according to claim 1, wherein one of the steps in manufacturing the engineered wood products comprises processing at a cutting station.

4. The method according to claim 1, wherein one of the steps in manufacturing the engineered wood products comprises processing at a dryer.

5. The method according to claim 1, wherein one of the steps in manufacturing the engineered wood products comprises processing at a blender.

6. The method according to claim 1, wherein one of the steps in manufacturing the engineered wood products comprises processing at a forming or pressing station.

7. The method according to claim 1, wherein one of the steps in manufacturing the engineered wood products comprises processing at a sawing station.

8. The method according to claim 1, wherein the plurality of properties comprises at least two of temperature, torque, force, pressure, flow, moisture content, rotating speed, energy consumption, strand size or geometry, density, material physical properties, material chemical properties and constituent content.

9. The method according to claim 1, wherein the external factor comprises at least one of season, time of day, ambient temperature, parameters from tree growing locations, machine wellness parameters, energy consumption, vibration, sound, reflection, particular labor or labor shift that performs an activity, worker behavior, data related to workers material prices, markets conditions, currency rates, storage capacity or supply chain data.

10. The method according to claim 1, wherein at least one of production yield or capacity, cost, profitability, and product quality is improved to a controlled level, while the rest of production yield or capacity, cost, profitability, and product quality are not affected within a controlled tolerance level or are purposely degraded to a controlled level.

11. Apparatus comprising:
a controller in operative communication with sensors, said controller being configured to control processing of wood particles into engineered wood products by processing interaction information, sensed by said sensors, associated with interaction between a plurality of steps in manufacturing the engineered wood products or interaction between a plurality of properties associated with materials used to make the engineered wood products, or interaction between said plurality of steps and said plurality of properties, or interaction between said plurality of steps or said plurality of properties and an additional external factor which is external to said plurality of steps or said plurality of properties, said controller being configured to process the interaction information with machine learning and deriving from the machine learning improvement information associated with improving properties or yields or profitability of the engineered wood products, and implementing the improvement information back in the processing of the wood particles to achieve engineered wood products with improved properties or yields or profitability.

12. The apparatus according to claim 11, wherein one of the steps in manufacturing the engineered wood products comprises processing at a log yard.

13. The apparatus according to claim 11, wherein one of the steps in manufacturing the engineered wood products comprises processing at a cutting station.

14. The apparatus according to claim 11, wherein one of the steps in manufacturing the engineered wood products comprises processing at a dryer.

15. The apparatus according to claim 11, wherein one of the steps in manufacturing the engineered wood products comprises processing at a blender.

16. The apparatus according to claim 11, wherein one of the steps in manufacturing the engineered wood products comprises processing at a forming or pressing station.

17. The apparatus according to claim 11, wherein one of the steps in manufacturing the engineered wood products comprises processing at a sawing station.

18. The apparatus according to claim 11, wherein the plurality of properties comprises at least two of temperature, torque, force, pressure, flow, moisture content, rotating speed, energy consumption, strand size or geometry, density, material physical properties, material chemical properties and constituent content.

19. The apparatus according to claim 11, wherein the external factor comprises at least one of season, time of day, ambient temperature, parameters from tree growing locations, machine wellness parameters, energy consumption, vibration, sound, reflection, particular labor or labor shift that performs an activity, worker behavior, data related to workers material prices, markets conditions, currency rates, storage capacity or supply chain data.

20. The apparatus according to claim 11, wherein at least one of production yield or capacity, cost, profitability, and product quality is improved to a controlled level, while the rest of production yield or capacity, cost, profitability, and product quality are not affected within a controlled tolerance level or are purposely degraded to a controlled level.
